(19) United States
(12) Patent Application Publication
(10) Pub. No.: US 2010/0208473 A1
(43) Pub. Date: Aug. 19, 2010

(54) LAMP SYSTEM AND LIGHTING APPARATUS

(75) Inventors: MAKOTO SAKAI, Chigasaki-Shi (JP); Keiichi Shimizu, Yokohama-Shi (JP); Toshiya Tanaka, Yokohama-Shi (JP); Shigeru Osawa, Yokohama-Shi (JP); Takeshi Hisayasu, Ota-Ku (JP); Kozo Ogawa, Yokosuka-Shi (JP); Takumi Suwa, Ota-Ku (JP); Hiotshi Kawano, Yokohama-Shi (JP)

Correspondence Address: DLA PIPER LLP US, P. O. BOX 2758, RESTON, VA, 20195, US

(73) Assignees: TOSHIBA LIGHTING & TECHNOLOGY CORPORATION, YOKOSUKA-SHI (JP); KABUSHIKI KAISHA TOSHIBA, MINATO-KU (JP)

(21) Appl. No.: 12/708,564

(22) Filed: Feb. 19, 2010

(30) Foreign Application Priority Data
Feb. 19, 2009 (JP) 2009-037190
Feb. 19, 2009 (JP) 2009-037192
Feb. 19, 2009 (JP) 2009-037193

(51) Int. Cl. F21V 29/00

(52) U.S. Cl. 362/373; 362/294

(57) ABSTRACT

A lamp system which can improve radiation performance is provided. A metallic heat conduction part provided along a peripheral portion of a metallic cover is fitted with a resin heat conduction part provided along a peripheral portion of a transparent cover so as to thermally contact each other. Heat generated by an LED is radiated into air from the metallic cover and at the same time is efficiently conducted from the metallic cover to the transparent cover to be radiated into air from the transparent cover.

### FIELD OF THE INVENTION

The present invention relates to a lamp system using an LED as a light source and a lighting apparatus using the lamp system.

### BACKGROUND OF THE INVENTION

Conventionally, there is a lamp system using a GX53 type cap as described in Japanese Laid-Open Patent Publication No. 2008-140606. This lamp system has a flat shape which is vertically thin and includes a metallic cover. The GX53 type cap is provided on an upper surface side of the metallic cover and a flat fluorescent lamp is provided on a lower surface side of the metallic cover as a light source together with a transparent cover which covers the fluorescent lamp. On an upper surface of the cap, a pair of lamp pins to be connected to a socket are provided in a protruding manner while a lighting device for making the fluorescent lamp light by receiving power supplied through the lamp pins is stored inside the cap. Then, heat generated by lighting of the fluorescent lamp is radiated to the outside from the metallic cover to suppress thermal influence to the lighting device or the like.

Meanwhile, when the lamp system is lit, the light source generates heat. Therefore, it is necessary to radiate the heat. Especially, in a case where an LED having a larger amount of heat generation than a discharge lamp is used as the light source, if radiation of heat is not sufficiently carried out, temperature of the LED itself becomes high to cause deterioration of the LED and shorter lifetime of the LED.

In the conventional lamp system using the GX53 type cap, a fluorescent lamp has been used as the light source. However, if the fluorescent lamp is simply replaced by an LED, sufficient radiation performance cannot be obtained and therefore a problem arises that the lamp cannot respond to high power output by the LED.

The present invention has been made in consideration of the above problems and is aimed at providing a lamp system which can improve radiation performance and a lighting apparatus using the lamp system.

### SUMMARY OF THE INVENTION

A lamp system of the present invention includes a substrate having a surface side on which an LED is mounted; a metallic cover positioned so as to thermally contact the other surface side of the substrate while having a metallic heat conduction part which is provided along a peripheral portion of a positioned area of the substrate; and a resin transparent cover which has a resin heat conduction part to be fitted with the metallic heat conduction part so as to thermally contact therewith and covers the substrate while being provided on the metallic cover.

Thus, it becomes possible to radiate the heat generated by the LED into air by heat conduction from the substrate to the metallic cover and at the same time to efficiently radiate the heat from the transparent cover into air because heat is efficiently conducted to the transparent cover having a large surface area exposed to the outside through the metallic heat conduction part and the resin heat conduction part. Thus, radiation performance of the lamp system can be improved and it becomes possible to respond to high power output by the LED. Moreover, since the transparent cover is made of resin, it becomes possible to easily form the resin heat conduction part to be a shape having higher thermal conductivity with the metallic heat conduction part, compared to a case of a glass cover. Therefore, it becomes possible to ensure high thermal conductivity.

Here, it is sufficient if the substrate is, for example, flat and has the one surface side on which the LED is mounted and the other surface side which can be thermally brought into contact with the metallic cover. To mount the LED on the substrate, a chip on board (COB) method to directly mount an LED chip on the substrate or a method to mount a surface mount device (SMD) package mounting an LED chip on the substrate may be used.

The metallic cover includes, for example, a metal having good thermal conductivity such as aluminum and may be formed to have a cylindrical or discoidal shape. The other surface side of the substrate may be brought into thermal surface contact with the one surface side of the metallic cover. On a peripheral surface part of the metallic cover, a plurality of fins may be formed or a vent hole which penetrates inside and outside of the metallic cover may be formed to improve radiation performance. The metallic heat conduction part may have any of the structures such as a groove portion, protrusion, or a screw structure as long as the resin heat conduction part can be fitted with the metallic heat conduction part.

The transparent cover is formed of a resin material having transparency such as acrylic. The resin heat conduction part may have any of the structures such as a protrusion, groove portion, or screw structures as long as it can be fitted with the metallic heat conduction part so as to thermally contact each other along the metallic heat conduction part.

A heat conduction filler for improving radiation performance may be mixed into the transparent cover. If a filler having high light diffusion property is used, light diffusion property of the transparent cover can be improved.

Moreover, the lamp system of the present invention includes a heat conduction connection means for connecting the metallic heat conduction part and the resin heat conduction part so as to enable heat conduction.

Thus, it becomes possible to improve thermal conductivity from the metallic heat conduction part to the resin heat conduction part to further improve radiation performance.

Here, the heat conduction connection means may be a heat conduction member such as silicon resin or grease to be intervened between the metallic heat conduction part and the resin heat conduction part or may be a structure such as a screwing structure or screw clamp to allow the metallic heat conduction part and the resin heat conduction part to be brought into close contact so as to enable heat conduction.

Further, in the lamp system of the present invention, a finger portion is provided on the transparent cover.

Thus, it becomes possible to place a finger on the finger portion to easily manipulate attachment and detachment of the lamp system to and from a socket device of the lighting apparatus.

Here, the shape of the finger portion may be convex or concave as long as a finger can be placed thereto. Moreover, although it is sufficient if at least one finger portion is provided, it becomes easier to manipulate if two or more finger portions are provided.

Further, the lighting apparatus of the present invention includes the lamp system.

Thus, it becomes possible to provide a lighting apparatus having a lamp system which has a long lifetime.

Here, the lighting apparatus may include an apparatus main body, a socket device for mounting the lamp system, and the like.

### BRIEF DESCRIPTION OF THE DRAWINGS

FIG. 1 is a cross-sectional view of a lamp system showing a first embodiment of the present invention,

FIG. 2 is an exploded perspective view of the lamp system,

FIG. 3 is a perspective view of the lamp system and a socket device,

FIG. 4 is a cross-sectional view in which a part of a reflector and a part of a transparent cover are enlarged, and

FIG. 5 is a cross-sectional view of a lighting apparatus.

FIG. 6 is a partial cross-sectional view of a metallic cover and a transparent cover of a lamp system showing a second embodiment.

FIG. 7 is a cross-sectional view in which a part of a reflector and a part of a transparent cover are enlarged showing a third embodiment.

FIG. 8 is a perspective view of a lamp system and a socket device showing a fourth embodiment and

FIG. 9 is cross-sectional view of a lighting apparatus.

FIG. 10 is a side view of a lamp system showing a fifth embodiment and

FIG. 11 is a front elevational view of the lamp system.

### DETAILED DESCRIPTION OF THE PREFERRED EMBODIMENT

Hereinafter, embodiments of the present invention will be explained with reference to the drawings.

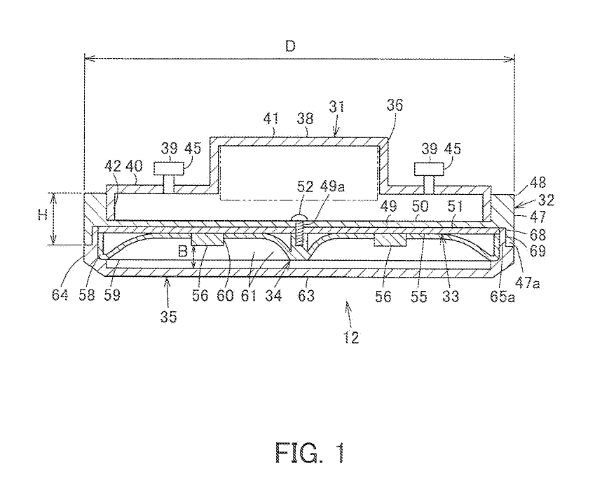

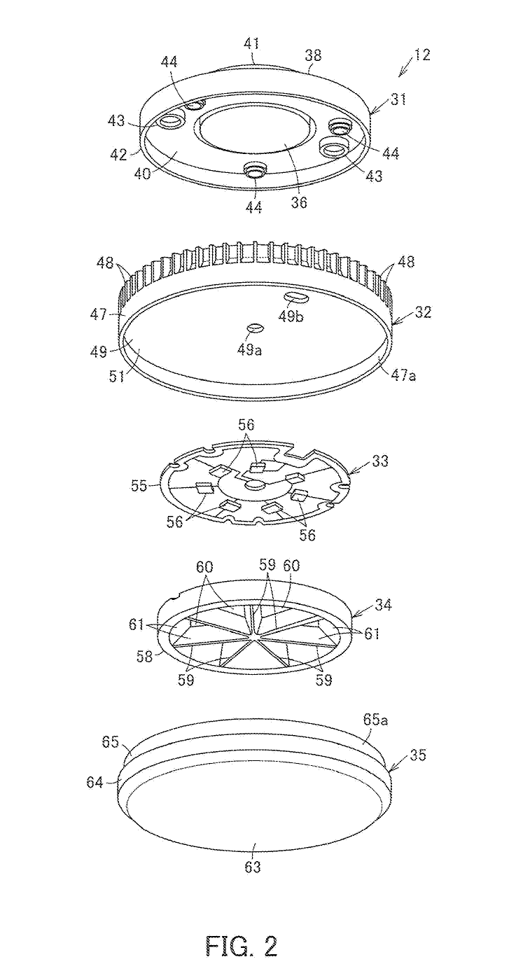

A first embodiment is shown in FIGS. 1 to 5.

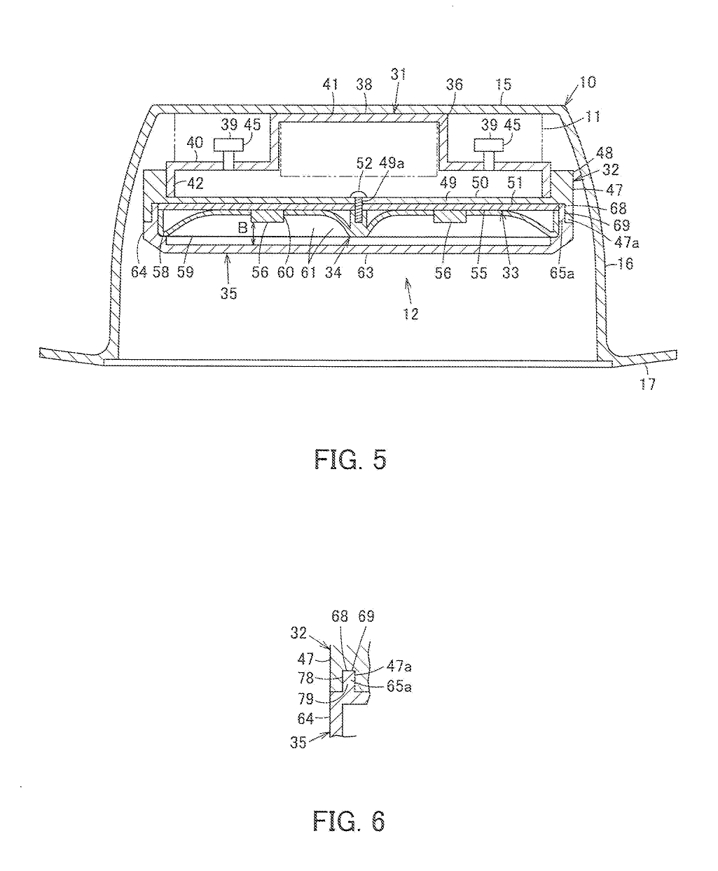

As shown in FIG. 5, the lighting apparatus is, for example, a downlight and includes an apparatus main body 10, a socket device 11 attached to the apparatus main body 10, and a flat lamp system 12 mounted to the socket device 11. Here, regarding the direction such as the vertical direction, the following explanation will be made on the assumption that a light source side which is one surface side of the lamp system 12 is a lower side and a cap side which is the other surface side is an upper side in a condition where the flat lamp system 12 is horizontally set.

The apparatus main body 10 is made of a metal or a resin and has a flat board part 15, a reflection board part 16, and an edge part 17 for attachment onto the ceiling. A lower surface of the apparatus main body 10 is opened. In this apparatus main body 10, the socket device 11 is provided on a lower surface of the flat board part 15 so that the lamp system 12 can be attached to or detached from the socket device 11 through the lower surface aperture of the apparatus main body 10.

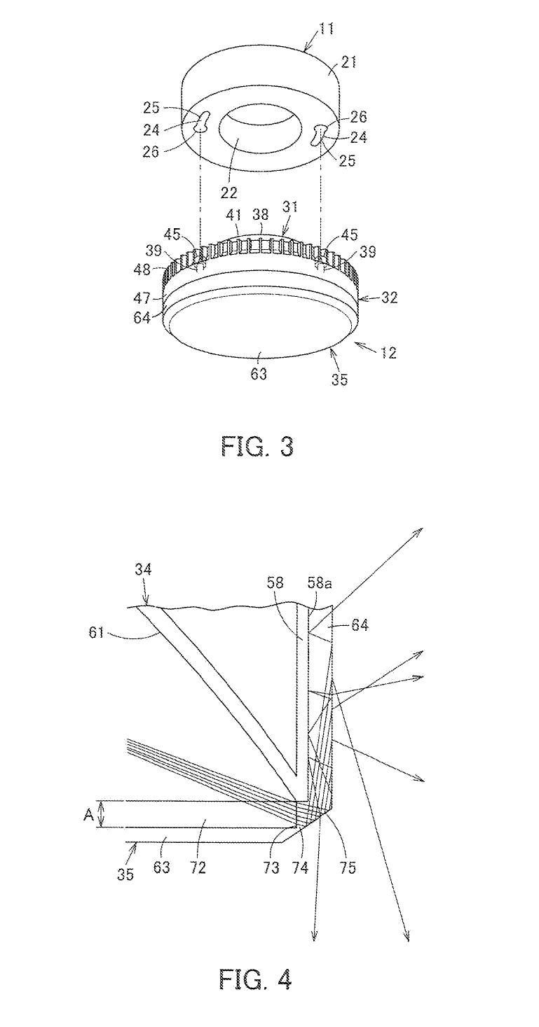

Moreover, as shown in FIG. 3, the socket device 11 corresponds to the GX53 type cap and therefore has a cylindrical socket device main body 21 which is made of an insulating synthetic resin. At the center of the socket device main body 21, a hole 22 is formed to penetrate in the vertical direction.

On a lower surface of the socket device main body 21, a pair of socket parts 24 are formed at positions which are symmetrical with respect to the center of the socket device main body 21. A connection hole 25 is formed on the socket parts 24 and at the same time, a holder (not shown) for supplying power is provided inside the connection hole 25. The connection hole 25 is a circular long hole which is a concentric circle with respect to the center of the socket device main body 21 and a large-diameter hole 26 is formed on one edge of the long hole.

Moreover, as shown in FIGS. 1 to 3, the lamp system 12 includes a cap 31 positioned on an upper surface side, a metallic cover 32 for attaching the cap 31 on the upper surface side, a substrate 33 being an LED module substrate attached to a lower surface side of the metallic cover 32 so as to thermally contact therewith, a reflector 34 attached to the metallic cover 32 via the substrate 33, a transparent cover 35 being a globe attached to cover the lower surface of the metallic cover 32, and lighting device 36 provided in the cap 31.

A GX53 type cap structure, for example, is adopted as the cap 31. The cap 31 includes a cap case 38 made of insulating synthetic resin having an insulating synthetic resin and a pair of lamp pins 39 projecting from an upper surface of the cap case 38. An external diameter of the cap 31 is approximately from 70 to 75 mm.

In the cap case 38, a flat and discoidal (circular) substrate part 40, a cylindrical projection part 41 projecting upward from the center of an upper surface of the substrate part 40, and a circular attachment part 42 projecting downward from a peripheral portion of the substrate part 40 are formed in an integrated manner. On the substrate part 40, a pair of attachment bosses 43 for attaching the pair of lamp pins 39 and a plurality of attachment holes 44 are formed. Then, the attachment part 42 is fitted into the metallic cover 32 and a plurality of screws (not shown) are screwed to the metallic cover 32 through the respective attachment holes 44 from the outside of the substrate part 40 to fix the cap case 38 to the metallic cover 32.

The pair of lamp pins 39 are positioned symmetrically with respect to the center of the lamp system 12 and project from the upper surface of the substrate part 40 of the cap case 38. A large-diameter part 45 is formed on the tip of the lamp pin 39. Then, the large-diameter part 45 of the respective lamp pins 39 is inserted from the large-diameter hole 26 of respective connection holes 25 of the socket device 11 and the lamp system 12 is rotated by a predetermined angle, for example, 10°. Thus, the lamp pin 39 is moved from the large-diameter hole 26 to the connection hole 25 and electrically connected to the holder provided inside the connection hole 25, and at the same time the large-diameter part 45 hooks on an edge part of the connection hole 25. Thus, the lamp system 12 is retained by the socket device 11.

Moreover, the metallic cover 32 is formed of a metallic material having good thermal conductivity such as aluminum and is formed in an integrated manner to have a flat and approximately cylindrical shape. The metallic cover 32 has an external circumference part 47 having an approximately cylindrical shape and on the external circumference part 47, a plurality of radiation fins 48 are formed on an approximately half area of the upper part side, which is the cap side.

Inside the external circumference part 47, a discoidal substrate attachment part 49 is formed in the middle of the vertical direction. Divided by the substrate attachment part 49, a cap side space 50 is formed on the upper surface side of the metallic cover 32 where the attachment part 42 of the cap case 38 is to be fitted and light source side space 51 on which the substrate 33 and the reflector 34 or the like are formed on the lower surface side of the metallic cover 32. At the center of the substrate attachment part 49, an attachment hole 49a for making an attachment screw 52 for fixing the reflector 34 to the metallic cover 32 pass through is formed. Further, a wiring hole 49b for making a lead wire to connect the substrate 33 and the lighting device 36 pass through is formed on the substrate attachment part 49.

The attachment screw 52 made to pass through the attachment hole 49a from the cap case 38 side of the substrate attachment part 49 is screwed at the center portion of the reflector 34 to fix the reflector 34 to the metallic cover 32. At this time, the substrate 33 positioned by the combination with the reflector 34 is sandwiched between the metallic cover 32 and the reflector 34 to be fixed and brought into surface contact so as to thermally contact the substrate attachment part 49.

Along the peripheral portion of the metallic cover 32, the metallic heat conduction part 47a to which the transparent cover 35 is fit so as to thermally contact therewith. The metallic heat conduction part 47a is formed by a circular inner surface part facing the light source side space 51 of the external circumference part 47.

Then, the maximum diameter D of the external circumference part 47 of the metallic cover 32 (and the transparent cover 35) is 80 to 150 mm, preferably 85 to 100 mm and as a specific example thereof, is approximately 90 mm. Moreover, height H of the external circumference part 47 of the metallic cover 32 is 5 to 25 mm, preferably 10 to 20 mm, and as a specific example thereof, is approximately 17 mm. Further, 2π (D/2) H/W which is an area of the external circumference surface of the external circumference part 47 per gross input power W to the lamp system 12 is within a range of 200 and 800 mm²/W. Further, the substrate 33 has a substrate main body 55 formed to have a flat and discoidal shape which is formed of a metallic material having superior thermal conductivity such as aluminum. On a lower surface of the substrate main body 55, a wiring pattern is formed via an insulation layer and a plurality of LEDs 56 are electrically and mechanically connected and provided on the wiring pattern.

The substrate main body 55 is sandwiched between the metallic cover 32 and the reflector 34 which is screwed to the metallic cover 32 so that the substrate main body 55 is attached to a lower surface of the substrate attachment part 49 of the metallic cover 32 so as to be in close surface contact therewith to enable heat conduction.

A method of surface mounting a surface mount device (SMD) package on which an LED chip is mounted on the substrate main body 55 is adopted, and a plurality of LEDs 56 are mounted on the substrate main body 55 along the circumferential direction around a hypothetical center axis of the lamp system 12.

Moreover, the reflector 34 is formed of, for example, a synthetic resin material and is formed to have a reflection surface having high reflection efficiency such as a white surface or a mirror surface. In the peripheral portion of the reflector 34, a cylindrical frame part 58 is formed, and on the inside of the frame part 58, a divider 59 for dividing the inside of the reflector 34 for each LED 56 is formed radially. An aperture 60 through which the LED 56 penetrates and a reflection surface 61 which faces the LED 56 to reflect light from the LED 56 to a desired direction in accordance with light distribution are formed inside the reflector 34 which is thus divided by the frame part 58 and the divider 59 for each LED 56. The reflection surface 61 is formed to be open and enlarged toward a front surface side so as to collect and reflect light from the LED 56 in, for example, a directly downward direction.

The reflector 34 is provided on a lower surface of the metallic cover 32 via the substrate 33 and is screwed to be fixed to the metallic cover 32 by the attachment screw 52 being screwed to the center portion of the reflector 34 through the attachment hole 49a from the upper surface side of the metallic cover 32. The reflector 34 is screwed to be fixed to the metallic cover 32 to make the substrate 33 be sandwiched between the reflector 34 and the metallic cover 32 so that the substrate 33 is brought into close surface contact with the substrate attachment surface 49 of the metallic cover 32.

Moreover, the transparent cover 35 is integrally formed of a synthetic resin material such as acrylic having both transparency and light guiding property as well as a light diffusion property. The transparent cover 35 has a discoidal front surface part 63 and a cylindrical side surface part 64 provided on a peripheral portion of the front surface part 63. A fitting part 65 to be fitted and fixed to an inner side of the external circumference part 47 of the metallic cover 32 is formed on the side surface part 64.

In a case where the transparent cover 35 has a light diffusion property, blast processing is carried out onto the inner surface side of the transparent cover 35 to make an external surface side of the transparent cover 35 into a smooth surface. Thus, dirt such as powder dust does not easily adhere to the external surface of the transparent cover 35 and the number of cleaning times can be reduced as well as easily carrying out cleaning.

The fitting part 65 is structured to be a resin heat conduction part 65a which is fitted along the metallic heat conduction part 47a so as to thermally contact therewith the metallic cover 32. The resin heat conduction part 65a is formed by an external surface part of the fitting part 65 to be fitted into the inner surface part of the external circumference part 47 of the metallic cover 32 which faces the light source side space 51.

The metallic heat conduction part 47a and the resin heat conduction part 65a are connected by a heat conduction connection means 68 so as to enable heat conduction. The heat conduction connection means 69 is constituted by a heat conductive material 69 such as a silicon resin or grease which intervenes between the metallic heat conduction part 47a and the resin heat conduction part 65a.

As shown in FIG. 4, a space 72 is formed between the front surface part 63 of the transparent cover 35 and the front surface of the reflector 34. Size A of the space 72 is, for example, within a range of approximately 1 and 3 mm, and preferably is 2 mm.

In a portion of the side surface part 64 facing the space 72 between the front surface part 63 and the front surface of the reflector 34, light introduction part 73 for introducing light from the LED 56 in the side surface part 64 is formed. The light introduction part 73 is provided in a projection part 74 which projects from the inner surface of the side surface part 64 toward the inner side to be engaged with a front edge of the frame part 58 of the reflector 34. An inner surface of the projection part 74 is parallel to the inner surface of the side surface part 64 and is provided at a position continuing to the front edge of the reflection surface 61 of the reflector 34.

At the external surface corner part of the front surface part 63 and the side surface part 64, a taper part 75 for reflecting the light introduced from the light introduction part 73 to the inside of the side surface part 64 is formed. The taper part 75 is inclined by 45° or more with respect to the side surface part 64 so that the light introduced from the light introduction part 73 can be efficiently reflected into the side surface part 64.

The side surface part 64 of the transparent cover 35 is provided along the external surface 58a of the frame part 58 of the reflector 34. However, the side surface part 64 and the external surface 58a can be in either close contact with each other or in close contact with each other.

The inner surface of the front surface part 63 of the transparent cover 35 and the inner surface of the side surface part 64 may be blast processed to make the surfaces into diffusion surfaces. The light introduction part 73 is a flat surface (or a lens surface) so as to efficiently introduce light.

Moreover, the lighting device 36 includes a circuit substrate and a plurality of lighting circuit parts (not shown) mounted on the circuit substrate and is provided on the inner side of the projection part 41 of the cap case 38. A light source input part of the lighting device 36 and the pair of lamp pins 39 are electrically connected by a lead wire (not shown) and an output part of the lighting device 36 and the substrate 33 are electrically connected by a lead wire (not shown) through the wiring hole 49b of the metallic cover 32.

Then, to mount the lamp system 12 thus structured to the socket device 11 of the apparatus main body 10, the respective lamp pins 39 of the lamp system 12 are inserted into the respective large-diameter holes 26 of the socket device 11 from below and subsequently the lamp system 12 is horizontally rotated in the mounting direction to move the respective lamp pins 39 from the respective large-diameter holes 26 to the respective connection holes 25 so that the respective lamp pins 39 are electrically connected to the holder of the socket device 11 and at the same time the large-diameter part 45 of the respective lamp pins 39 are hooked on an edge part of the respective connection holes 25. Thus, the lamp system 12 can be mounted to the socket device 11.

In a condition where the lamp system 12 is mounted to the socket device 11, the projection part 41 of the lamp system 12 is inserted into the hole part 22 of the socket device 11. At this time, if an edge surface of the projection part 41 or the metallic cover 32 is brought into close contact with the apparatus main body 10 (not shown) so as to enable heat conduction, the heat of the lamp system 12 can be released to the apparatus main body 10.

Moreover, when the LED 56 of the lamp system 12 is lit, heat generated by the LED 56 is thermally conducted from the substrate 33 to the substrate attachment part 49 of the metallic cover 32 and then from the substrate attachment part 49 to the external circumference part 47. The heat thus thermally conducted to the external circumference part 47 of the metallic cover 32 is efficiently radiated from the external circumference surface of the external circumference part 47 into air.

Especially, since the radiation fin 48 is provided to the external circumference part 47, the surface area of the external circumference part 47 becomes larger than a plain one to improve radiation efficiency. Here, as long as satisfactory radiation performance can be obtained, the external circumference part 47 may be a plain side surface without the radiation fin 48 provided on the outer circumference part 47.

Further, since the resin heat conduction part 65a of the transparent cover 35 is fitted along the metallic heat conduction part 47a of the metallic cover 32 so as to thermally contact therewith, heat is efficiently conducted from the metallic cover 32 to the transparent cover 35 through the metallic heat conduction part 47a and the resin heat conduction part 65a. Therefore, the heat conducted to the transparent cover 35 can be radiated into air from the side surface part 64 and the front surface part 63 of the transparent cover 35.

Therefore, in the lamp system 12, heat generated by the LED 56 can be thermally conducted from the substrate 33 to the metallic cover 32 so that the heat can be radiated into air and at the same time the heat can be efficiently conducted from the metallic cover 32 to the transparent cover 35 through the metallic heat conduction part 47a and the resin heat conduction part 65a. Since the transparent cover 35 is formed flatly with its maximum diameter D being within a range of 80 and 150 mm and the external circumference surface and the front surface thereof are exposed to the outside, the surface area of the transparent cover 35 is relatively large. Therefore, heat of the LED 56 can be radiated into air through the transparent cover 35 and it becomes possible to improve radiation performance of the whole of the lamp system 12 and to respond to high power output by the LED 56.

Since radiation performance of the whole of the lamp system 12 is improved, surface temperature of the metallic cover 32 can be maintained to 80° C. or lower and surface temperature of the transparent cover 35 can be maintained to 70° C. or lower.

Moreover, since the transparent cover 35 is made of resin, the cover has advantages such as being superior in radiation performance than a conventional glass cover and that the resin heat conduction part 65a can be easily shaped so as to fit the metallic heat conduction part 47a.

Further, if the transparent cover 35 is a glass cover, due to large difference in thermal expansion between the transparent cover 35 and the metallic cover 32, clearance in a fitting portion with the metallic cover 32 must be set large taking a case of breaking of the glass or the like into consideration. As a result thereof, thermal conductivity from the metallic cover 32 to the transparent cover 35 is lowered. Meanwhile, if the transparent cover 35 is made of resin, because a difference in thermal expansion between the transparent cover 35 and the metallic cover 32 is smaller than the case of using a glass cover, and the resin cover can flexibly respond to deformation, clearance in the fitting portion with the metallic cover 32 can be set small. Moreover, because resin is superior in formability, it becomes easy to have a fitting structure in which the contact area between the both heat conduction parts 47a and 65a is enlarged. As a result thereof, thermal conductivity from the metallic cover 32 to the transparent cover 35 can be increased.

Here, it is preferable that the substantial contact area between the both heat conduction parts 47a and 65a in the present embodiment is between 600 and 2000 mm² and the contact area per gross input power is between 15 and 150 mm/W.

Moreover, since the metallic heat conduction part 47a and the resin heat conduction part 65a are connected so as to enable heat conduction by the heat conduction connection means 68, thermal conductivity from the metallic heat conduction part 47a to the resin heat conduction part 65a can be improved and heat radiation performance can be further improved.

In particular, as a heat conduction connection means 68, using the heat conductive material 69, such as a silicon resin or grease which intervenes between the metallic heat conduction part 47a and the resin heat conduction part 65a can increase contact between the metallic heat conduction part 47a and the resin heat conduction part 65a and increase heat conduction efficiency.

Here, the minimum space A between the LED 56 and the inner surface of the transparent cover 35 is within a range of 3 and 15 mm, preferably between 5 and 10 mm, taking heat resistance of the resin and reduction in thickness of the lamp system 12 into consideration.

Further, part of the light emitted by the LED 56 directly goes to the front surface part 63 of the transparent cover 35 while part of the light is reflected by the reflection surface 61 to go to the front surface part 63 of the transparent cover 35. Then, the light passes through the front surface part 63 of the transparent cover 35 and is irradiated to the outside.

Further, as shown in FIG. 4, part of the light emitted by the LED 56 is made incident into the side surface part 64 from the light introduction part 73 of the side surface part 64 through the space 72 between the front surface part 63 and the front surface of the reflector 34. The light made incident into the side surface part 64 is reflected by the taper part 75 to be guided into the side surface part 64 and is output from the external surface of the side surface part 64.

Therefore, the light is output from the front surface part 63 and side surface part 64 of the transparent cover 35 and when the lamp system 12 is seen, both the front surface part 63 and side surface part 64 of the transparent cover 35 appear to illuminate.

Thus, in the lamp system 12, the space 72 is provided between the front surface part 63 of the transparent cover 35 and the front surface of the reflector 34 to introduce light of the LED 56 from the light introduction part 73 of the side surface part 64 facing the space 72 so as to illuminate the side surface part 64, thereby, even if the reflector 34 is not provided in the transparent cover 35, the whole of the transparent cover 35 can be illuminated. Therefore, it becomes possible to increase merchantability of the lamp system 12 because a user does not feel any discomfort when the lamp system 12 is lit.

Moreover, since the light introduction part 73 of the transparent cover 35 is provided at a position continuing to the front edge of the reflection surface 61 of the reflector 34, it becomes possible to efficiently introduce the light of the LED 56 into the side surface part 64.

Further, due to the taper part 75 provided at the external surface corner of the front surface part 63 and the side surface part 64 of the transparent cover 35, the light introduced from the light introduction part 73 is reflected into the side surface part 64. Therefore, the whole of the side surface part 64 can be uniformly illuminated.

Further, due to the frame part 58 of the reflector 34 facing the inner surface of the side surface part 64 of the transparent cover 35, the light introduced into the side surface part 64 can be reflected so that the light can be efficiently output from the external surface of the side surface part 64. Therefore, luminance of the side surface part 64 can be increased.

Next, a second embodiment is shown in FIG. 6. FIG. 6 is a partial cross-sectional view of the metallic cover 32 and the transparent cover 35 of the lamp system 12.

A circular groove part 78, which is open to the lower surface side of the external circumference part 47, functions as the metallic heat conduction part 47a of the metallic cover 32 and a circular projection 79 which perpendicularly protrudes from an upper edge surface of the side surface part 64 to be fitted with the groove part 78 functions as the resin heat conduction part 65a of the transparent cover 35.

The groove part 78 and the projection 79 are fitted to bring the metallic cover 32 and the transparent cover 35 into contact so as to enable heat conduction. In the case of this structure, the contact area between the groove part 78 and the projection 79 can be large and therefore thermal conductivity can be increased. Moreover, by making the heat conductive material 69 intervene between the groove part 78 and the projection 79, contact between the metallic heat conduction part 47a and the resin heat conduction part 65a can be improved and heat conduction efficiency can be further improved.

Here, the heat conduction connection means 68 is not limited to the structure of allowing the heat conductive material 69 to intervene between the metallic heat conduction part 47a and the resin heat conduction part 65a. A screwing structure by which the metallic heat conduction part 47a and the resin heat conduction part 65a are screwed to each other or a structure that the metallic heat conduction part 47a and the resin heat conduction part 65a are screwed tightly so as to be in close contact may be adopted.

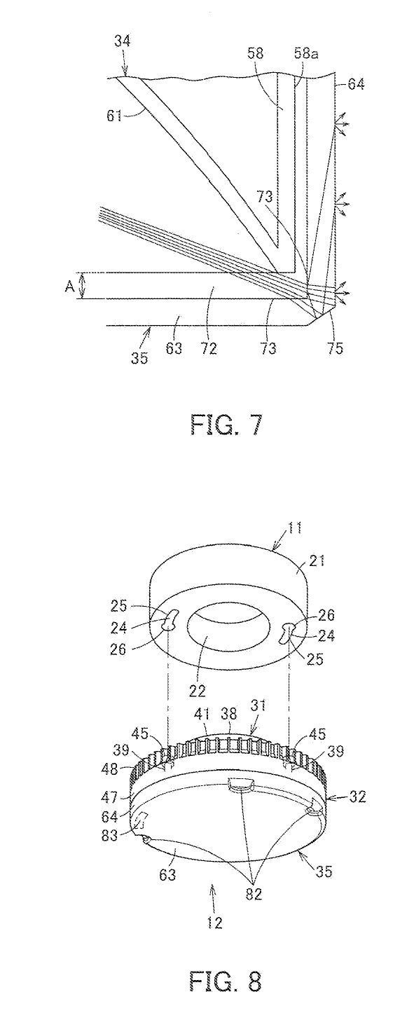

Next, a third embodiment is shown in FIG. 7. FIG. 7 is a cross-sectional view in which a part of the reflector 34 and a part of the transparent cover 35 of the lamp system 12 are enlarged.

An example in which the front surface and side surface of the reflector 34 and the transparent cover 35 are not in contact is shown. In this example, the light introduction part 73 of the transparent cover 35 becomes the inner surface of the front surface part 63 and the side surface part 64 facing the space 72. In this example also, similar to the first embodiment, the light of the LED 56 can be introduced from the light introduction part 73 and guided to the side surface part 64.

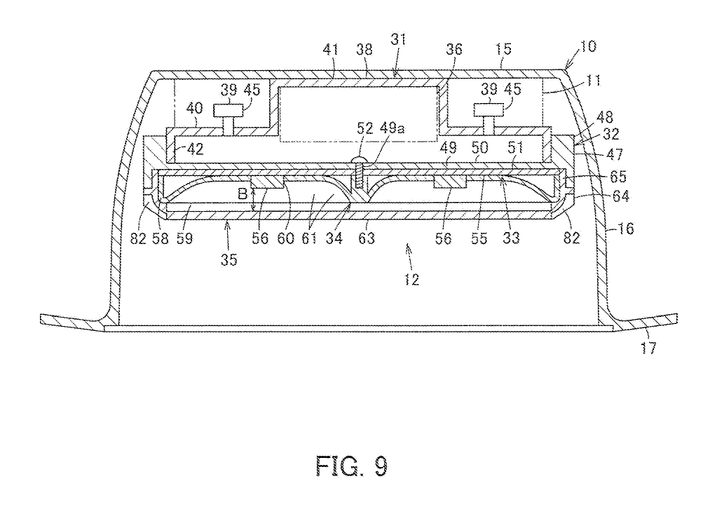

Next, a fourth embodiment is shown in FIGS. 8 and 9. FIG. 8 is a perspective view of the lamp system 12 and the socket device 11 and FIG. 9 is a cross-sectional view of the lighting apparatus.

A plurality of finger portions 82 on which fingers are placed when a user grips the peripheral portion of the lamp system 12 are formed on the peripheral portion of the transparent cover 35 which is a lower edge side of the lamp system 12. These finger portions 82 are formed as concave portions which concave by approximately a thickness of the transparent cover 35 at the corner between the front surface part 63 and the side surface part 64 of the transparent cover 35. The depression on the front surface part 63 side of the transparent cover 35 is formed to be a concave curved surface which corresponds to the shape of the ball of a finger to allow the ball of a finger to fit thereto.

In the present embodiment, three finger portions 82 are formed on the peripheral portion of the transparent cover 35 and the finger portions 82 are provided at the most appropriate positions for a user to grip the transparent cover 35 by using three fingers, a thumb, an index finger, and a middle finger.

Among the finger portions 82, two finger portions 82 are provided at positions corresponding to the positions of the pair of lamp pins 39 protruding from the cap 31 positioned opposite to the transparent cover 35.

Moreover, in a place such as the peripheral portion of the transparent cover 35 or the external circumference surface of the metallic cover 32 in the apparatus which can be seen in a condition where the fluorescent lamp is attached to the socket device 11, a temperature display part 83 for displaying the temperature condition of the lamp system 12 is provided. On the temperature display part 83, a caution, for example, “CAUTION HIGH TEMPERATURE” is described by use of, for example, a heat sensitive paint having characteristics that the paint disappears if the temperature becomes lower than 40° C., emits light when the temperature reaches 40° C. or more, and increases in emission intensity as the temperature rises. The temperature display part 83 is more effective if it is provided in the vicinity of the finger portion 82.

The heat sensitive paint is also called a thermo paint or a chameleon paint which includes a compound as a pigment which reversibly changes in color under a certain temperature. The change of color occurs along with transformation of the shape of a crystal of a pigment compound used for the paint due to heat. Mercury iodide complex salt or the like is used as the pigment.

If the temperature reaches 40° C. or more after the lamp system 12 is turned on, color of the caution described with the heat sensitive paint changes into a visible color to alert a user to be careful when touching the lamp system 12.

Thus, when the lamp system 12 thus structured is attached to or detached from the socket device 11, using the finger portions 82 provided on the transparent cover 35 enables a user to easily attach or detach the lamp system 12.

That is, in the lamp system 12, the finger portions 82 are provided on the lower edge side which is opposite to the upper surface side where the cap 31 of the flat lamp system 12 is provided. Therefore, in a case where a small lighting apparatus is used, even if a space between the external circumference surface of the flat lamp system 12 and the inner wall surface of the reflection board 16 of the apparatus main body 10 is narrow, a user can place fingers on the finger portions 82 to easily attach or detach the cap 31 to or from the socket device 11 of the apparatus main body 10, and it becomes possible to easily attach or detach the lamp system 12.

In particular, since the finger portions 82 are formed as concave portions at the corner between the front surface part 63 and the side surface part 64 of the transparent cover 35, even if the space between the external circumference surface of the flat lamp system 12 and the inner wall surface of the reflection board 16 of the apparatus main body 10 is narrow, it is easy to place fingers on the finger portions 82 and to easily manipulate the apparatus.

Moreover, since the finger portions 82 are provided at the most appropriate positions on the peripheral portion of the transparent cover 35 for a user to grip by three fingers, a thumb, an index finger, and a middle finger, it is easy for a user to place these three fingers on each of the finger portions 82 to easily grip and rotate the lamp system 12.

Further, among the finger portions 82, two finger portions 82 are provided at positions corresponding to the positions of the pair of lamp pins 39 protruding from the cap 31 positioned opposite to the transparent cover 35 and therefore even if the lamp pins 39 on the upper surface side of the lamp system 12 cannot be seen when the lamp system 12 is mounted to the socket device 11, the positions of the lamp pins 39 can be judged from the positions of the finger portions 82 and the lamp pins 39 can be inserted into the large-diameter hole 26 of the socket device 11. Therefore, the lamp system 12 can easily be mounted.

Further, since the finger portions 82 are provided on the resin transparent cover 35, it is easier to provide the finger portions 82 compared to the case where the glass transparent cover 35 is used.

Further, if the finger portions 82 are concave portions concave from the surface of the transparent cover 35 and dimensions of the concave portion are set to approximately the thickness of the transparent cover 35, it becomes possible to reduce the influence of the passing light.

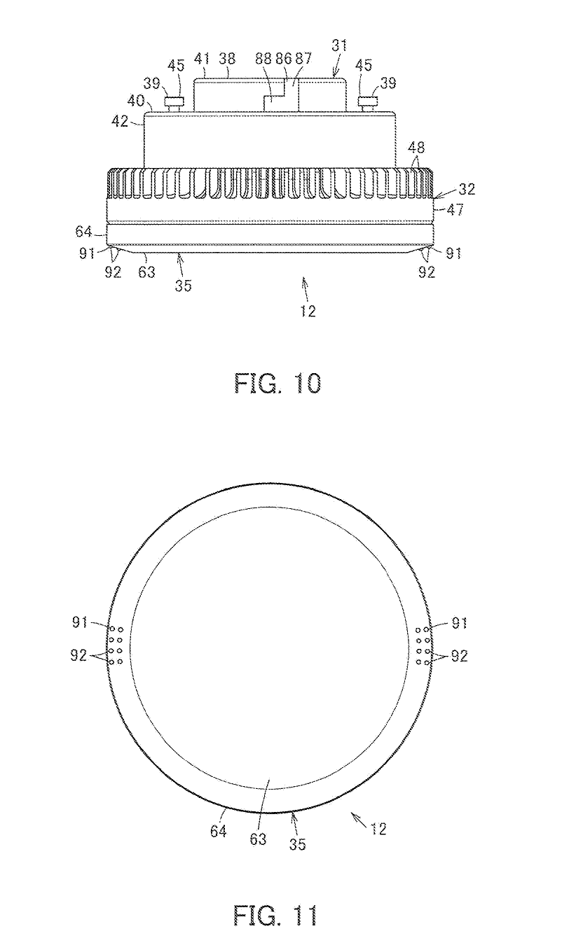

Next, a fifth embodiment is shown in FIGS. 10 and 11. FIG. 10 is a side view of the lamp system and FIG. 11 is a front elevational view of the lamp system.

The lamp system 12 has a longer attachment part 42 which protrudes from the substrate part 40 of the cap 31 and the lamp system 12 having a higher height overall compared to the other embodiments.

Moreover, on the circumference surface of the projection part 41 of the cap 31, a pair of concave parts 86 are formed at positions which are symmetrical with respect to the center of the cap 31. The concave parts 86 include an attachment/detachment groove 87 which opens to the edge surface 43 of the projection part 41 and a retention groove 88 which is open in the circumferential direction from a lower edge of the attachment/detachment groove 87.

Here, although not shown, on the inner circumference surface of the hole 22 of the socket device 11, a pair of convex parts which fit with the respective concave parts 86 are provided in a protruding manner in symmetrical positions with respect to the center of the socket device 11.

Then, when the lamp system 12 is mounted to the socket device 11, the attachment/detachment groove 87 of the respective concave parts 86 of the lamp system 12 is matched to the respective convex parts of the socket device 11 and then the lamp system 12 is raised and rotated in the mounting direction, thereby the retention groove 88 of the concave portion 86 is fitted into the convex part of the socket device 11 and regulates rotation of the lamp system 12 in the mounting direction, and this condition is the mounting position of the lamp system 12 to the socket device 11. In the mounting position of the lamp system 12, the retention groove 88 of the concave part 86 is fitted into the convex part of the socket device 11 and therefore the lamp system 12 is prevented from falling.

Moreover, in the peripheral portion of the front surface part 63 of the transparent cover 35, a pair of marks 91 for indicating the positions for the pair of lamp pins 39 are provided corresponding to lines connecting the pair of lamp pins 39. The marks 91 are constituted by a plurality of protrusions 92 which protrude from the front surface 63.

Then, when the lamp system 12 is mounted to the socket device 11, the positions of the pair of lamp pins 39 which hide from the front surface side of the transparent cover 35 can be recognized by visually checking or touching the pair of marks 91. Thus, it becomes easier to insert the pair of lamp pins 39 into the large-diameter holes 26 of the pair of connection holes 25 of the socket device 11 and to improve mountability of the lamp device 12.

Here, the protrusion 92 of the mark 91 may be used as the finger portion 82.

What is claimed is:

1. A lamp system comprising:
the substrate having a surface side on which an LED is mounted;
the metallic cover positioned so as to thermally contact the other surface side of the substrate while having a metallic heat conduction part which is provided along a peripheral portion of a positioned area of the substrate;
a resin transparent cover which has a resin heat conduction part to be fitted with the metallic heat conduction part so as to thermally contact therewith and covers the substrate while being provided or the metallic cover.

2. The lamp system according to claim 1 further comprising a heat conduction connection means for connecting the metallic heat conduction part and the resin heat conduction part so as to enable heat conduction.

3. The lamp system according to claim 1, wherein a finger portion is provided on the transparent cover.

4. A lighting apparatus comprising the lamp system according to claim 1.
